(19) United States
(12) Patent Application Publication
(10) Pub. No.: US 2008/0221247 A1
(43) Pub. Date: Sep. 11, 2008

(54) METHOD OF GLUING HYDROPHOBIC AND OLEOPHOBIC SUBSTRATES WHICH ARE INTENDED FOR PACKAGING

(75) Inventors: Nicolas SAJOT, Compiegne (FR); Benoit Pollacchi, Compiegne (FR); Saida Sellak, Compiegne (FR)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: BOSTIK S.A., PARIS (FR)

(21) Appl. No.: 12/124,036

(22) Filed: May 20, 2008

Related U.S. Application Data
(63) Continuation of application No. 10/815,914, filed on Apr. 2, 2004, now abandoned.
Application No. 10/815,914 is a continuation of application No. PCT/FR02/03335, filed on Oct. 1, 2002.

(30) Foreign Application Priority Data
Oct. 2, 2001 (FR) 01/12654

(51) Int. Cl. C09J 11/08; C09J 125/08

(52) U.S. Cl. 524/271

(57) ABSTRACT

The invention relates to a method of gluing substrates which are hydrophobic and oleophobic as a result of having been treated earlier using a fluorinated compound, said substrates being intended for packaging. The inventive method consists in applying an adhesive to at least one of the substrates, said adhesive comprising: a) 5 to 50 weight percent of at least one styrenic block copolymer (preferably, 15 to 30%); b) 20 to 60 weight percent of at least one tackifying resin which is compatible with the non-styrene phase (preferably, 35 to 55%); c) 0 to 20 weight percent of at least one tackifying resin which is compatible with the styrene phase and, (preferably, 5 to 15%); d) 5 to 25 weight percent of at least one thermofusible wax (preferably, 10 to 17%); e) 3 to 20 weight percent of liquid plasticisers which are normally used in thermofusible adhesives; and/or f) additives. In this way, said mixture presents the following characteristics: (i) a viscosity of between 400 and 3000 mPa·s at 170° C. (preferably, between 700 and 1400 mPa·s); and (ii) a softening point included between 75 and 120° C.

This invention has as its object a process for gluing together substrates that are made oleophobic and hydrophobic, using an adhesive based on styrene block copolymers. It also has as its object adhesives that make possible the gluing of so-called difficult substrates such as those made oleophobic and hydrophobic.

The gluing of the materials of the packaging industry, in particular paper and cardboard, is a well-known technique. In practice, industrial concerns use a broad range of adhesives, and in particular thermofusible adhesives, very often referred to by the professionals as Hot Melt or HMA, English initials for Hot Melt Adhesives, an abbreviation which will be used below to designate them. These HMA generally consist of the following primary components: a polymer that imparts to the final adhesive its structure, a main “tackifying” adhesion agent, and a plasticizer such as a wax or a mineral oil that brings to the adhesive its thermal and rheological properties.

In the large majority of cases, the choice of adhesive will first be based on the selection of the polymer. The polymer that is used in the HMA consists of, for example, the ethylene-type copolymers, such as vinyl ethylene-acetate (EVA), amorphous poly-alpha-olefins (APAO), polyolefins that are synthesized by metallocene catalysis, polyethylenes of low molecular weight or else amorphous polypropylenes. Also proposed for the polymer are the styrene block copolymers where the latter is combined with a co-monomer such as isoprene or butadiene, hydrogenated forms of these components. The selection will naturally be made on a criterion of structural property but which broadly takes into account the notion of cost of raw materials.

Certain packaging variants, however, pose specific adhesion problems, the “difficult” packages, which is the case in particular of packages (cardboard for cases, kraft paper for bags, etc. . . . ) that are pretreated to impart to them a resistance to liquids (hydrophobic) and to oils and greases (lipophobic). Furthermore, this type of package that should naturally offer all the conventional advantages that are known in terms of protecting materials to be packaged, strength, longevity, appearance or various other functionalities, can be subjected to important variations of temperatures that generally range from −10° C. to +40° C., and even 40° C. to +80° C. Actually, the preparation of food products, for example, as well as their preservation or the conditions in which they are stored, require that the packaging be resistant and continue to ensure its function under extreme temperatures. Thus, the gluing should be effective during all of the packaging operations or the life cycle of the packaging.

The permanent improvement of barrier properties to water, to oils and fatty substances, substrates that are intended for the packaging market, in particular because of the evolution and effectiveness of mass or “size press” treatments (on the back and the front) by increasingly higher-performing fluorinated polymers sometimes makes it difficult to effectively glue this type of substrate with the usual adhesives, in particular when the packaging is subjected to significant temperature variations.

A recent example of this evolution is the use of fluorinated compounds such as the fluorinated polyacrylates in the treatment of substrates that are intended for packaging so as to impart to them oleophobic and hydrophobic barrier properties, namely both at a high level of resistance to water and a high level of resistance to oils and fatty substances.

These fluorinated compounds of various types are used in an aqueous phase and are therefore hydrodilutable. They are either small fluorinated molecules, for example fluorinated phosphate salts, or fluorinated sulfate salts, or fluorinated acrylic copolymers, i.e., copolymers of which at least one monomer comprises a bead(s) being deposited on the substrate(s), the setting speed as well as the machinability are the critical parameters here. The contents being warm, during the closing of the bag, the adhesive is to withstand temperatures on the order of at least 60° C. so as not to reopen.

In the area of the manufacture of cases, it is necessary to note for:
the shaping of the case where the glue bead is deposited on the foot of the case or the treated side. The adhesive should have good performance levels of between −10° C. to +60° C., for the packaging and the transport of cases.
The closing of the case where the glue bead is deposited on the cardboard flap or flaps. The setting speed, its temperature behavior as well as its machinability are the critical parameters here.

The implementations that are described here are simply examples of the most commonly encountered difficulties.

The adhesive should be able to be used for any assembly of which at least one of the substrates has undergone a hydrophobic and oleophobic treatment.

The adhesive should therefore have very specific and sometimes contradictory characteristics, short setting time, good wetting power, very good thermal behavior of the adhesion after temperature cycles located between −10° C. and +60° C., and even between −40° C. and +80° C., as well as a low viscosity because of the fluorinated treatment.

The process according to the invention is used in the sense of resolving this problem, in particular by a selection of the polymer and its structure.

The invention has as its object a process for gluing together so-called difficult substrates that are intended for the manufacture of packages, which consists in applying on at least one of the substrates an adhesive that comprises:
a) 5 to 50% by weight of block copolymer that is obtained from styrene monomers and at least one other comonomer such as ethylene, propylene, isoprene, butadiene, butylene or any other comonomer that forms a two-phase medium with the styrene phase.
b) 20 to 60% by weight of at least one tackifying resin that is compatible with the non-styrene phase, having a softening point that is measured according to the EN 1238 standard encompassed between 5 and 150° C.
c) 0 to 20% by weight of at least one tackifying resin that is compatible with the styrene phase
d) 5 to 25% by weight of at least one wax, among the waxes that are conventionally used in the thermofusible adhesives that have a melting point of between 70 to 120° C.
e) 3 to 20% by weight of liquid plasticizers that are conventionally used in the thermofusible adhesives such as mineral oils with a paraffinic or napthenic nature, or else polybutenes or phthalates, whereby said adhesive exhibits a viscosity of between 400 and 3000 mPa·s at 170° C. and a softening point, measured according to said ball-ring method, encompassed between 75 and 120° C.

The adhesive of the process of the invention optionally can comprise various additives such as antioxidants . . . .

Component a) according to the process of the invention (the copolymer), has a diblock, triblock or multiblock, linear, radial or star-shaped structure, whereby the intermediate block consists of at least one of the comonomers listed above and can undergo a hydrogenation phase. The block copolymer or the mixture of block copolymers comprises a mass percent of the styrene phase in the polymer that is between 10 and 40% and preferably between 20 and 35%, a mass percent of diblock structures in the variable polymer generally encompassed between 0 and 50%, a flow index (MFI=Melt Flow Index) that is measured according to condition No. 10 of the NFT 51-016 standard of between 2 and 70 g10 min.

Component a) is preferably a styrene-ethylene butylene-styrene block copolymer (designated SEBS) or any other close structure. It is possible to mix this component a) with other polymers such as the copolymers of ethylene, polyolefins, polymers that are obtained by a metallocene catalysis path. The content of the adhesive in component a) in general between 5 and 50% by mass is preferably between 15 and 30%.

For the most part, component b) is selected from among the resins that are conventionally used in the thermofusible adhesives, such as:
the rosin or its derivatives, rosin ester, optionally hydrogenated,
polyterpenes, terpene-phenolic compounds or derivatives thereof,
optionally hydrogenated polymers that are obtained from aliphatic or aromatic fractions or the mixtures of these fractions,
   having a softening point that is measured according to the EN 1238 standard encompassed between 5 and 150° C., preferably between 70 and 125° C. The majority resin preferably will be non-aromatic with a notable polar nature. The content of component b) is between 20 and 60% by mass and preferably between 35 and 55%.

Component c) consists of resin or a mixture of resins that are conventionally used, such as the polymers that are obtained from aromatic fractions or else poly-alpha-methylstyrene. It is preferably selected from among the resins that are obtained from the polymerization of alpha-methylstyrene, for example having a softening point that is measured according to the EN 1238 standard encompassed between 80 and 160° C. The content of component c) is between 0 and 20% by mass and preferably between 5 and 15%.

Component d) is selected for the most part from among the so-called microcrystalline waxes that are conventionally used in the thermofusible adhesives, having a melting point (ASTM D127 method) of between 70 and 100° C., preferably between 80 and 95° C. In a minority amount, component d) can contain synthesis waxes such as polyolefins with short chains that are rather linear, obtained by polymerization according to standard processes (Ziegler Natta; Fischer Tropsch), whose melting point that is measured according to the standard (ASTM D127 method) is high, generally between 80 and 150° C. and preferably between 90 and 120° C. The content of component d) is between 5 and 25%, and preferably between 10 and 17% by mass.

Polymers of another nature can be present in a minority way in the adhesive, for example the ethylene-vinyl acetate copolymers (EVA), the polyolefins of the processes or of various natures, and the other styrene block copolymers.

The various additives will be, for example, the antioxidants that are conventionally used in the thermofusible adhesives or in the industry for transformation of thermoplastic compounds, such as hindered phenolic derivatives, phosphites or mixtures thereof.

The viscosity of the thermofusible adhesive of the process of the invention will be between 400 and 3000 mPa·s at 170° C. and preferably between 700 and 1400. Its softening point that is measured according to the so-called ball-ring method that is known to one skilled in the art will be encompassed between 75 and 120° C.

The adhesive according to the process of the invention is obtained by mixing a), b), c), d) and e) as well as the possible additives, by any suitable means, for example by a simple mixing at a temperature of between 150 and 170° C.

The adhesive can be easily characterized by chemical analysis according to the standard processes for deformulation and identification of different fractions, in particular by infra-red spectrometry, nuclear magnetic resonance 1H and 13C, elementary micro-analysis, gel permeation chromatography or high-performance chromatography or else by differential calorimetry (DSC or Differential Scanning Calorimetry).

On a practical plane, the adhesives of the process of the invention are applied according to the standard methods that are used in the area of thermofusible adhesives, on the packaging chain or else on the edge of the latter. Starting from a boiler tank, via heated and heat-insulated pipes, by extrusion nozzles: controlled deposition of one or more beads on a first substrate and mating with the second substrate, with optional pressing of the adhesive joint thus produced. The low-viscosity HMA can be applied by any other possible means such as, for example, a lipped nozzle, multi-line nozzles, disk, imprint or else by the Sift Proof process developed by the Nordson Company. The temperature of the adhesive at the time of application is conventionally between 150 and 180° C.

This type of process is conducted according to certain specific parameters. For example, the machine open time is the time that passes between the application of the adhesive on the first substrate and mating with the second substrate. The machine pressing time is the time immediately after gluing during which the two glued substrates are kept in contact with a force that is at least equal to the force of reopening the packaging without adhesive.

The adhesive is applied on thin substrates, i.e., of a thickness that is generally encompassed between 0.05 and about 2 mm, whereby these substrates can be part of a thicker complex structure. This substrate often can be based on paper or cardboard, such as virgin or recycled kraft paper, having a low density or on the contrary a compact thin substrate, optionally treated by fluorinated compounds or on the surface by acrylic varnish or UV-reticulated varnish, or of specific coatings, optionally with non-coated zones, reserves, to make possible the deposition and the hooking of the adhesive on the substrate.

The nature of the various substrates used is selected from among identical or different or composite materials, most of the time based on paper or cardboard, metal, for example, aluminum, or plastics, such as polyethylene, polypropylene, terephthalate polyethylene, polystyrene, . . . .

### EXAMPLES

The process of the invention is illustrated by 6 examples in which were compared, under conditions representative of the use, the performance levels of various HMA formulas of the prior art and HMA according to the invention.

To evaluate the performance levels of the HMA in the process according to the invention, various tests are carried out: the determinations of viscosity, open time, setting time, heat behavior and temperature behavior (−10° C. to +60° C.).
To evaluate the open time, a bead of adhesive, with an amount of 2 g per linear meter, is deposited, with a setting time of 1 s, at a temperature of 170° C., on a standard double-corrugated cardboard (140 and 200 g/m² covers with a cobb of 1800 respectively of 135 g/m² and 145 g/m² measured according to the EN 20535 standard), then a second cardboard of the same nature is attached to said cardboard after successive periods of 1, 2, 3, 4, 5 seconds . . . while the extraction of the fibers of the cardboard is less than 90% of the surface covered by the adhesive joint. The open time corresponds to the maximum duration in terms of which the adhesive bonds the two cardboards.
The setting time is evaluated by carrying out the inverse operation with an adhesive that has an open time of 1 s and by carrying out the operation of debonding the two cardboards after successive periods of 1, 2, 3, 4, 5 . . . seconds until the adhesive has bonded the two cardboards, i.e., that more than 90% of fiber removal from the surface of the glued cardboard is obtained. The setting time corresponds to the minimum duration in terms of which the adhesive bonds the two cardboards.
The heat behavior is evaluated with the help of the S.A.F.T. method (shear adhesion failure temperature): the samples are prepared in the same way as for the determination of open time and setting time, on flexible substrates such as INTEGRAL® and ALIPACK® or cardboards that are treated by fluorinated compound. One day after the gluing, one of the substrates is suspended while a mass of 250 g (for a sample width of 5 cm) is attached to the other, thus causing a force of creep on the adhesive bead. The unit is put into an oven and undergoes a rise in temperature starting from 23° C. at a rate of 5° C. per half-hour. The result of the test is the temperature at which the assembly yielded under creep stress.
The temperature behavior tests are made in the same way as for the evaluation of open time, but the substrates that are used are flexible substrates such as INTEGRAL®, ALIPACK® or cardboards that are treated by a fluorinated compound. After manual gluing, with an adhesive bead of 2 g/linear meter, at 170° C. and a pressing time of 1 s, the samples are subjected to the accepted temperature, in a ventilated oven. The operation is carried out on at least 4 sample of which the average is taken.

The substrates that are used for our tests are FORAPERLE® 325 treated papers or cardboards with a concentration of about 3%.

By measuring the oleophobia on these cellulose fibrous substrates, according to the standardized method of the TAPPI 559 test kit, values of between 8 and 12, and even greater than 12, are found. In addition, the typical characteristics for the kraft paper are as follows:

| CHARACTERISTICS | UNIT | MEAN |
|---|---|---|
| M² Weight | Grs/m² | 70 |
| Moisture | % | 4.6 |
| SM Breaking Load | KN/m | 6.5 |
| ST Breaking Load | KN/m | 3.0 |
| SM Elongation | % | 2 |
| ST Elongation | % | 6.5 |
| SM Tearing | mN | 750 |
| ST Tearing | mN | 840 |
| Dry Burst | Kpa | 270 |
| Water Cobb | Grs/m² | 25 |
| Edge L'homargy Porosity | ml/min | 1150 |
| Middle L'homargy Porosity | ml/min | 1300 |

The raw materials that are used in the examples are as follows:

| | |
|---|---|
| Kraton ® G1652 | Copolymer of ethylene-butylene and styrene, Melt Index 10, % |
| | styrene 30 and no diblock, marketed by Kraton Polymers |
| Kraton ® G1726 | Copolymer of ethylene-butylene and styrene, Melt Index 65, % |
| | styrene 30 and 70% diblock, marketed by Kraton Polymers |
| Kraton ® G1657 | Copolymer of ethylene-butylene and styrene, Melt Index 8, % |
| | styrene 13 and 30% diblock, marketed by Kraton Polymers |
| Evatane ® 18-500 | EVA Melt Index 500, vinyl acetate 18%, marketed by Atofina |
| Evatane ® 28-420 | EVA Melt Index 420, vinyl acetate 28%, marketed by Atofina |
| Evatane ® 33-400 | EVA Melt Index 400, vinyl acetate 33%, marketed by Atofina |
| Vestoplast ® 704 | Propene-rich APAO, softening point 105° C. (DIN 52011 |
| | modified), viscosity 3500 mPa · s at 190° C. (DIN 53019 modified), |
| | marketed by Degussa Hüls |
| Vestoplast ® 408 | Butene-rich APAO, softening point 118° C. (DIN 52011 modified), |
| | viscosity 8000 mPa · s at 190° C. (DIN 53019 modified), marketed |
| | by Degussa Hüls |
| Régalrez ® 1078 | C₉, obtained by copolymerization of α-methyl-styrene, vinyl- |
| (US) | toluene and indene, totally hydrogenated, softening point 78° C. |
| | (ASTM E28), marketed by Hercules |
| Régalrez ® 1018 | C₉, obtained by copolymerization of α-methyl-styrene, vinyl- |
| (US) | toluene and indene, totally hydrogenated; liquid, marketed by |
| | Hercules |
| Wintack ® 95 | Aliphatic resin of C₅, softening point 95° C., marketed by Hercules |
| Piccotex ® 120 | Resin that is obtained from the polymerization of pure monomers |
| | of α methyl-styrene, softening point 120° C. (ASTM E 28), |
| | marketed by Hercules |
| Norsolène ® | Resin that is obtained from the polymerization of pure monomers |
| W110 | of α methyl-styrene, softening point 105-115° C. (ISO 4625), |
| | marketed by Cray Valley |
| Foral ® AX-E | Resin that is obtained from the hydrogenated rosin, softening point |
| | 81° C. (ASTM E 28), marketed by Hercules |
| Foral ® 85-E | Resin that is obtained from the hydrogenated and glycerol- |
| | esterified rosin, softening point 85° C. (ASTM E 28), marketed by |
| | Hercules |
| Dertophène ® T | Phenolic terpene resin that is obtained from the condensation of |
| | terebenthine gasolines with phenol, softening point 95° C. (ASTM |
| | E28), marketed by DRT |
| Dertoline ® DEG 2 | Resin that is obtained from the hydrogenated and diethylene |
| | glycol-esterified rosin, softening point 35° C., marketed by DRT |
| Sylvarès ® 540 | Resin that is obtained by copolymerizarion of styrene with α |
| | methyl-styrene or vinyl-toluene, softening point 75° C., marketed |
| | by Arizona Chemical |
| Besquare ® 185 | So-called microcrystalline wax, consisting of saturated |
| | hydrocarbons with branched and cyclized chains, softening point |
| | about 90° C. (ASTM D 127), marketed by Bareco Products |
| Paraflint ® H2 | Hard crystalline PE wax obtained by the Fischer Tropsch process, |
| | DSC melting point 105-110° C., viscosity 10 mPa · s at 120° C., |
| | marketed by Sasol-Schumann |
| Napvis ® D 200 | Polybutene obtained by polymerization of a C₄ fraction containing |
| | a high proportion of isobutene, flow point 24° C., marketed by BP- |
| | Amoco |
| Primol ® 352 | Mineral oil with majority paraffin compounds, marketed by Esso |
| | France |
| Irganox ® 1010 | Phenolic antioxidant marketed by Ciba Geigy |

The examples including the following comparison examples whose results are combined in the Table, pages 12 and 13, will make the invention better understood.

### Examples 1 to 6

Examples 1 and 2 target first-generation adhesives of the prior art based on EVA (Example 1) and APAO (Example 2); Examples 3 and 4 are comparison examples that use SEBS bases described in the prior art and Examples 5 and 6 of the examples based on SEBS according to the process of the invention.

Based on these examples, it is noted that:
It is necessary to make a careful choice of the SEBS to be used. As Example 4 shows, the SEBS with a low MFI (Melt Flow Index) provide a high viscosity that is unsuitable to the process according to the invention.
The use of SEBS with suitable MFI (Example 3) is not adequate, however. It is necessary in particular to combine a mixture of oil and wax according to the invention to obtain a good adhesion at −10° C.
The amorphous APAO-type polymers (Example 2) do not make it possible to fill the specifications in terms of setting speed. As for EVA (Example 1), they are not polyvalent enough to ensure a gluing between −10° C. and +60° C. on the hydrophobic and oleophobic so-called difficult substrates, according to the process of the invention.
The combination of SEBS with suitable MFI, polar hydrogenated resin as well as oil and wax (Examples 5 and 6) according to the invention is a condition that is necessary for responding to all applicable specifications.
The thermal behavior at +60° C., with the low-viscosity products, can be attained only with suitable SEBS with MFI, combined with waxes. The latter make it possible to reduce the viscosity of the rubber, as Examples 5 and 6 show, without penalizing the thermal behavior.
The thermal behavior at −10° C., combined with the characteristics that are described above, is reached by determining exactly the good polymer/resin ratio (Examples 5 and 6). Excess resin has a tendency to solidify the adhesive and to deteriorate the behavior when cold (Example 3).

| | Examples | | | | | |
|---|---|---|---|---|---|---|
| Components | 1^{a} | 2^{a} | 3^{a} | 4^{a} | 5^{b} | 6^{b} |
| Kraron ® G 1652 | | | | 13.5 | 15 | 15 |
| Kraton ® G 1657 | | | 7.5 | 9.0 | | |
| Kraton ® G 1726 | | | 5 | | 10 | 10 |
| Evatane ® 18-500 | 15 | | | | | |
| Evatane ® 28-420 | 15 | | | | | |
| Evatane ® 33-400 | 15 | | | | | |
| Vestoplast ® 704 | | 26 | | | | |
| Vestoplast ® 408 | | 26 | | | | |
| Regalrez ® R1078 | | | 70 | | | |
| Regalrez ® R1018 | | | 17 | | | |
| Wintack ® 95 | | | | 68.0 | | |
| Sylvares ® 540 | 28 | | | | | |
| Dertophene ® T | | 29 | | | | |
| Foral ® AX-E | | | | | 17 | 12 |
| Foral ® 85 | | | | | 17.5 | 22.5 |
| Norsolene ® 110 | | | | | 15 | 15 |
| Dertoline ® DEG 2 | 9 | | | | | |
| Paraflint ® H2 | 17 | | | | | |
| Besquare ® 185 | | | | | 10 | 10 |
| Napvis ® D200 | | 18 | | | | |
| Primol ® 352 | | | | 9.0 | 15 | 15 |
| Irganox ® 1010 | 1 | 1 | 0.5 | 0.5 | 0.5 | 0.5 |
| Viscosity (mPa · s) at | 1900 | 2000 | 460 | 5900 | 1200 | 1300 |
| 170° C. | | | | | | |
| Open Time(s) | 10 | >20 | 10 | 10 | >10 | >10 |
| Setting time(s) | 5-7 | >20 | 4-6 | 5-7 | 5-7 | 5-7 |
| Behavior at −10° C. on | 50 | RA | RA | RA | 100 80 | |
| ALIPACK ® or | | | | | | |
| INTEGRAL ®^{c} | | | | | | |
| Behavior at −10° C. on | RA | RA | RA | RA | 85 | RA |
| FORAPERLE ®^{c} treated | | | | | | |
| cardboard | | | | | | |
| Behavior at +60° C. on | RA | 20 | 10 | 100 | RC | 30 |
| ALIPACK ® or | | | | | | |
| INTEGRAL ®^{c} | | | | | | |
| Behavior at +60° C. on | RA | 90 | RC | 100 | 100 | RC |
| FORAPERLE ®^{c} treated | | | | | | |
| cardboard | | | | | | |
| SAFT (°)^{c} | 75 | 70 | 40 | 50 | 55 | 55 |

^{a}Comparison;
^{b}According to the invention;
^{c}Results expressed in % fiber extraction;
RA = Adhesive failure,
RC = Cohesive failure of adhesive joint

1-18. (canceled)

19. A thermofusible adhesive comprising:
(a) a styrene block copolymer, wherein the styrene block copolymer is a block copolymer or mixture of block copolymers that is obtained from at least one styrene monomer and at least one second monomer which forms a two-phase medium with the styrene monomer, the two-phase medium having a styrene phase and a non-styrene phase, the styrene block copolymer including a diblock, triblock, multi-block, linear, radial or star-shaped structure, whereby the second monomer is an intermediate block, whereby said styrene block copolymer includes:
a mass percent of the styrene phase in the polymer that is between 10 and 40%;
a mass percent of diblock structures that is between 0 and 50%; and
a flow index (MFI=Melt Flow Index) according to condition No. 10 of the NFT 51-016 standard of between 2 and 70 g10 min;
(b) a first tackifying resin, wherein the first tackifying resin is a resin or mixture of resins that is compatible with the non-styrene phase, wherein the first tackifying resin comprises:
a resin or its derivatives,
polyterpenes, terpene-phenolic compounds or derivatives thereof,
optionally hydrogenated polymers that are obtainable from aliphatic or aroma tic fractions or the mixtures thereof,
wherein the first tackifying resin has a softening point that is measured according to the EN 1238 standard that is between 5 and 150 C;
(c) 5 to 15% by weight of a second tackifying resin, wherein the second tackifying resin is a resin or mixture of resins that is compatible with the styrene phase, wherein the second tackifying resin includes polymers that are obtainable from aromatic fractions or from the polymerization of the alpha-methyl styrene, wherein the second tackifying resin has a softening point that is measured according to the EN 1238 standard that is between 60 and 160 C;
(d) 5 to 25% by weight of at least one thermofusible wax; and
(e) 3 to 20% by weight of liquid plasticizers,
wherein the adhesive exhibits a viscosity of between 400 and 3000 mPa·s at 170 C and a softening point between 75 and 120 C.

20. The thermofusible adhesive of claim 19, wherein the adhesive further comprises:
5 to 50% by weight of the styrene block copolymer, and
20 to 60% by weight of the first tackifying resin.

21. The thermofusible adhesive of claim 19, wherein the styrene block copolymer is a styrene/ethylene/butylene/styrene (SEBS) copolymer.

22. The thermofusible adhesive of claim 19, wherein the wax comprises substantially a microcrystalline wax or mixture thereof that has a melting point measured according to the ASTM D 127 method that is between 70 and 120 C.

23. The thermofusible adhesive of claim 19, wherein the liquid plasticizer or the mixture of liquid plasticizers includes parrafinnic or napthenic mineral oils, polybutenes or phthalates.

24. The thermofusible adhesive of claim 19, wherein the second tackifying resin is non-aromatic polar resin.

25. A package that comprises substrates of which at least one is hydrophobic and lipophobic and is adhered to the others by the adhesive of claim 19.

26. The package according to claim 24, comprising identical, different or composite materials that include paper, cardboard, metal, or plastics.

27. A process for gluing together substrates that are made hydrophobic and oleophobic by prior treatment by a fluorinated compound, the process comprising a step of applying on at least one of the substrates the adhesive of claim 19.

28. The thermofusible adhesive of claim 19 further comprising:
15 to 30% by weight of the styrene block copolymer,
35 to 55% by weight of the first tackifying resin,
10 to 17% by weight of the at least one thermofusible wax,
wherein the adhesive exhibits a viscosity of between 700 and 1400 mPa·s at 170 C and a softening point between 75 and 120 C.

29. The thermofusible adhesive of claim 19, wherein the second monomer is ethylene, propylene, isoprene, butadiene, or butylene.

30. The thermofusible adhesive of claim 19, wherein the mass percent of the styrene phase in the polymer is between 20 and 35%.

31. The thermofusible adhesive of claim 19, wherein the first tackifying resin comprises a resin ester or its derivative.

32. The thermofusible adhesive of claim 19, wherein the first tackifying resin comprises a hydrogenated resin or its derivative.
